(19) United States
(12) Patent Application Publication
(10) Pub. No.: US 2013/0041798 A1
(43) Pub. Date: Feb. 14, 2013

(54) Debt Collection Database

(71) Applicant: Kenneth Unger, New York, NY (US)

(72) Inventor: Kenneth Unger, New York, NY (US)

(21) Appl. No.: 13/571,270

(22) Filed: Aug. 9, 2012

Related U.S. Application Data
(60) Provisional application No. 61/521,451, filed on Aug. 9, 2011.

(51) Int. Cl. G06Q 40/00

(52) U.S. Cl. 705/35

(57) ABSTRACT

A secured server computer hosting a conventional website, displaying a relational database to participating members that contains identification information pertaining to individuals maintaining an outstanding balance of preferably $150.00, or having a history of delinquent payments with one or more member businesses. The present invention functions to alert small businesses to delinquent customers, as well as to facilitate the resolution of debts between crediting businesses and individual debtors. Automated alerts are enacted through direct mediums such as email, telephone, and conventional postal mail, providing the debtor a chance to dispute accusations, or resolve listed debts prior to being marked as delinquent by the present invention.

### CONTINUITY

This is a non-provisional application of provisional patent application No. 61/521,451, filed on Aug. 9, 2011, and priority is claimed thereto.

### FIELD OF THE PRESENT INVENTION

The present invention, a secured server computer, hosting a relational database, containing identification information pertaining to a select set of individuals who preferably maintain an outstanding balance greater than $150.00 with an independent creditor, such as a small business, which would then be integrated into a website-based network of creditors, providing access to the database of indebted individuals to all subscribers or users of the network, namely, other small businesses. The present invention facilitates the communication between similar creditors regarding clients that have failed to pay their bills within the specified time allotted and is configured to mitigate the resolution of debt via email, telephone, or conventional postal mail alerts to the indebted party, as well as to report the current status of the debt, indicating if it has been paid, pending resolution, awaiting confirmation, partially paid, or resolved.

### BACKGROUND OF THE PRESENT INVENTION

While many benefits inherently come with running an independently owned business, it is certainly not without its drawbacks. Depending on the industry of the small business, maintaining a steady and reliable revenue stream can be difficult, especially when the business is in its infancy. This is due to significant start up costs, unexpected loss of investment, as well as a tendency towards a lack of initial clients providing reliable or consistent work. For example, it takes a great deal of time to become successful for a brand new hair salon, as all of the potential clients in the area are generally used to getting their hair cut wherever it happened to be cut last, or at their neighborhood barber shop. This is especially true in the hair industry, given that people tend to be creatures of habit, and the friendly nature of hair stylists' conversations creates a lasting rapport with customers, bringing them back in future visits.

Similarly, small businesses often experience unexpected or unforeseen losses of capital, supplies, materials, or even labor. For example, new restaurants have significant start-up costs as well, and even after the restaurant is open for business, the restaurant can still unexpectedly lose money when a customer walks out on a check, or if an employee steals food. However, other industries suffer just as much, if not more, when an individual or party fails or refuses to pay for the provided goods or services. For instance, a typical pesticide company one would hire for the removal of pests from a home or office frequently chooses to bill its clients after service is complete. The bill is mailed rather than presented to the customer prior to the service being performed often for the sake of convenience, as pesticide workers have the ability to simply come to spray a home while no members of the household are present, as to not inconvenience individuals who work common workday hours during the day. Pest control invoices tend to be higher than typical restaurant tabs, but usually remain low enough to not to warrant court action to sue the individual in the event of negligence, non-payment, or incomplete payment. The court costs could likely outweigh the potential settlement, costing the company even further than the initial debt. It is for this reason that many small business owners would prefer to avoid doing business with such delinquent customers, simply to avoid the potential hassle of chasing down their hard-earned money.

Unfortunately, these delinquent customers are often repeat offenders, painting the town red with their debt, and owing money for services to business owners across town. In large cities, such as New York City, N.Y. or Los Angeles, Calif., individuals can get away with keeping an outstanding balance with numerous small businesses as there is no immediate way to inform other businesses to avoid doing business with such an individual. These delinquent individuals manage to evade their bills, as well as the authorities, by utilizing a different small business each time a need arises. For example, say an individual hires Exterminator A, who comes and eliminates pests with a first treatment spraying of pesticides as contracted. However, the initial treatment is rarely enough to ensure pests will not return in a month or so.

If the individual fails to pay the bill for the initial treatment, but continues to need service he or she cannot afford or refuses to pay for, the individual would likely not return to Exterminator A for a second service, knowing that they will not perform the work until they are paid for the first visit. Therefore, the individual then contracts Exterminator B to do the second spraying, and furthermore, he or she fails to pay that bill, and hires Exterminator C for the final treatment. In effect, the individual has scammed three companies out of their pesticide chemicals, time, and effort, while getting off essentially scot-free, despite failing to pay three debts. Worse yet, nothing is stopping the individual from performing this scam repeatedly, given that the debts remain small. The scammed exterminators could certainly inform the credit agencies regarding the non-payments, but this doesn't help the small business resolve the debt at all—it merely taints the credit report of the individual running the scam. If there were an effective way to track delinquent customers, fewer businesses would be scammed as they would be informed not to provide service to the specified individual until his or her name were cleared, or to merely ask for payment in advance of performing a service, or delivering goods.

Thus, there is a need for an interactive system and website that can facilitate communication between small businesses pertaining to delinquent individuals who have failed to pay their bills or have other billing issues outstanding, as well as an alert framework designed to give debtors a final chance to resolve a debt prior to flagging the individual for delinquent payments.

### SUMMARY OF THE PRESENT INVENTION

The present invention is a computer, hosting a secured server network, maintaining a relational database containing a list of identification information regarding individuals who maintain an outstanding balance with a business or creditor, or have a history of delinquent payments. It is the intent of the present invention to facilitate communication between both creditors (primarily reputable small businesses) and debtors, as well as between an array of small businesses subscribed to the network, with the goal of warning other businesses about a specific customer's fraudulent, late, or incomplete payment or non-payment. This interactive and interconnected network, known as the Customer Credit Bureau, strictly acts as a reporting bureau that documents the history of delinquent customers by publishing their debts to the public on the internet for other members of the Bureau to see for a period of five years. This is intended to assist participating businesses to make more informed decisions regarding the customers they choose to do business with.

The Customer Credit Bureau is a platform/sharing network of information among companies pertaining to customer debt. This platform displays customer's debts in numerical values for those delinquent in their payments for 60 days or more, with an amount owed of $150.00 or more. The network enables crediting businesses to report when a customer is delinquent as well as be notified when one of their customers is listed by another member as a delinquent. Initially, a member, namely a small business, would post an individual's debt to the relational database located on a secured server machine hosting the website, which would then act as a collection mechanism. The system would send a notice to the customer via email, telephone, or regular USPS mail, prior to formally posting the debt to the network, informing them that their debt has been reported to the Customer Credit Bureau. This letter indicates the quantity of monies owed as well as the duration the debt has been outstanding. The system would then provide the customer with a chance to respond by paying the full amount, a partial amount, negotiating the debt or a payment plan, or disputing the amount that is owed in writing. It would also provide a time frame to make payment or file a dispute prior to ‘marking’ or ‘blacklisting’ the individual's name in the relational database. The letter or email would also indicate to the customer that if the payment is preferably not received or disputed in a designated time period of 30 business days, the debt would be made public for all participating businesses to see on the network. If the debt is published to the network, it will remain for a period of five years, regardless of if the debt has been resolved or not. The debt entry will be kept up to date via the creditor, who will be prompted to update the status of outstanding debts upon logging into the network each day.

In order to assist with the validation of debt accusations from small businesses in the network towards alleged delinquent customers, crediting subscribers are given the option of providing documented proof of the individual's debt or non-payment upon reporting a delinquent debtor. The creditor will be prompted, upon creating the debt entry in the database, to upload all files including invoices and other materials supporting their case. For example, a crediting company may post contractual agreements, receipts, invoices, or other related documents that will provide a foundation for the claims against the indebted. This will additionally help to insure the accusing company against counter-claims made by the debtor, in the event that he or she is in a state of disbelief about the debt, or if he or she simply fails to remember the debt's existence, and denies or objects to the claims. During this timeframe, debtors are given a chance to resolve the debt with the creditor prior to marking the individual, and making the debt public to the network. A “Debt Resolution” page is available on the website, acting as an indirect medium of communication between the two parties.

### A BRIEF DESCRIPTION OF THE DRAWINGS

FIG. 1 is a flow chart of the present invention showing the path of debt resolution and reporting via the network.

FIG. 2 is an example of the layout of the Customer Credit Bureau website founded on a relational database, hosted on a secured server, which outputs the website framework.

FIG. 3 is a flow chart detailing the interaction and communication between website components (database, host, server and user) of the present invention.

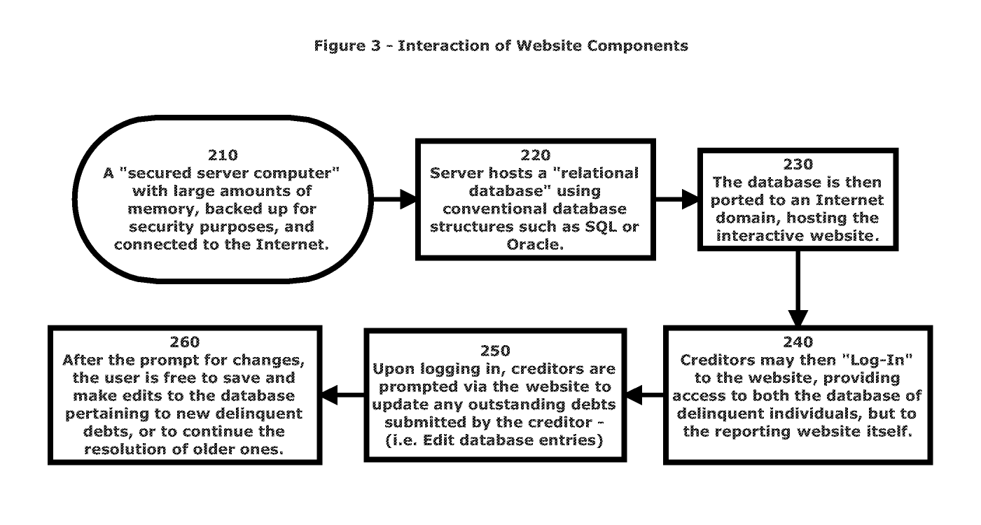

### DETAILED DESCRIPTION

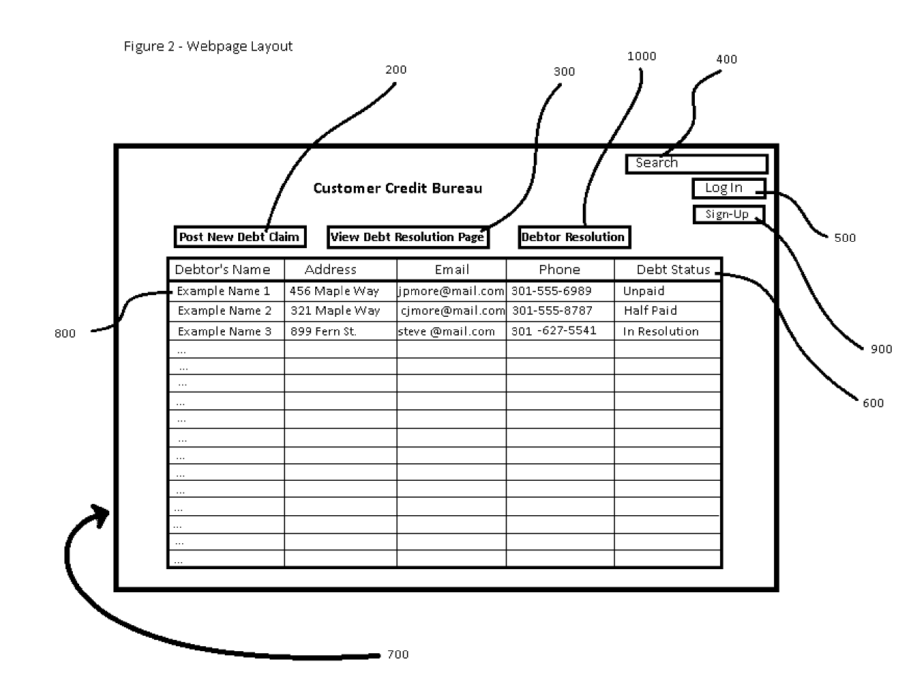

The present invention, a computer, hosting a secured server (210), maintaining a database (220) of relational information containing a list of identification information pertaining to individuals who maintain an outstanding balance with a business or creditor, or have a history of delinquent payments. It is configured to output the information stored within the database (220) to a secured website (230). An example of the website representation of the present embodiment of the invention can be seen in FIG. 2, wherein users of the present invention, primarily reputable small businesses, may signup to become a member of the network, granting them access to the database (220), as well as rights to add or edit outstanding debt information pertaining to a customer or client that has been delinquent in his or her timely payment for provided goods or services.

Visitors have few options available to them immediately upon accessing the network in which the present invention is embedded by navigating to the homepage of the website (230). First, if a visitor is new to the network, the visitor is provided the option to click “Sign-Up” (900) and register their business with the website (230) and database (220) network. Additionally, visitors with an established account—known as ‘users’—are presented with an option to click the “Log-In” link (500) on the homepage in order to log-in to the website with their credentials, and be granted full access to the database (220). After logging in, the user is also granted access to the remainder of the website, including, but not limited to, access to the “Post New Debt Claim” link (200), the delinquent debtor search link (400), and the debt resolution page link (300).

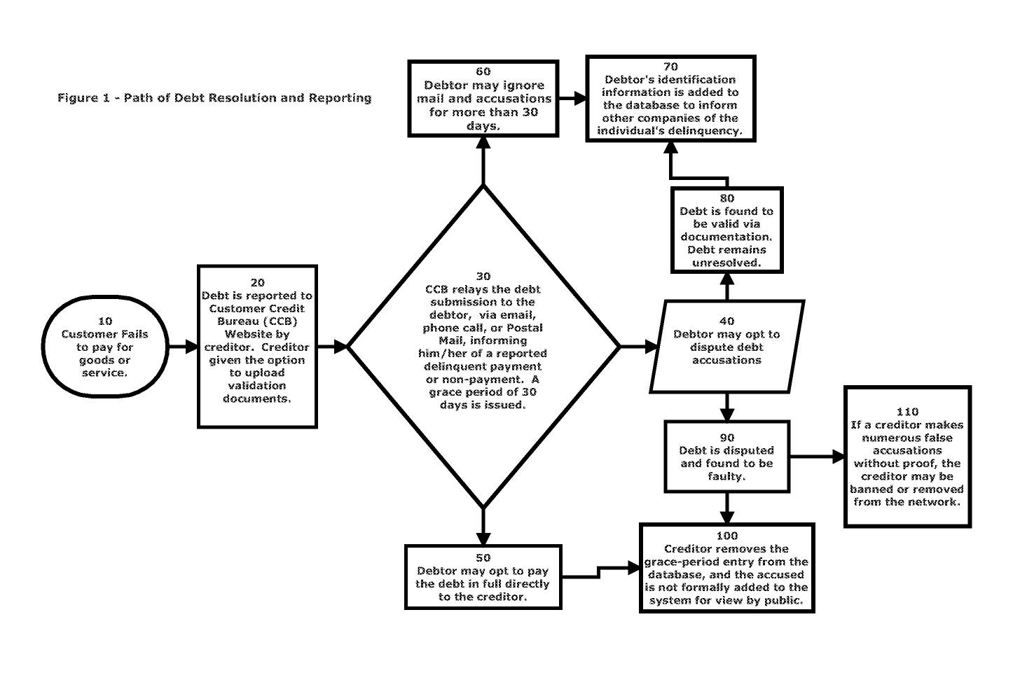

As it is the intent of the preferred embodiment of the present invention to inform and alert small businesses to delinquent customers, as well as to provide an outlet for debt resolution, the process by which debt is reported and resolved is outlined below, as referenced in FIG. 1.

Presuming that a given customer has failed to pay the full amount for goods and services provided by a small business (10), and said small business is a member of the database network of the present invention, with an established account, the debt may then be reported (20) electronically to the network, referred to as the “Customer Credit Bureau” (CCB) via the “Post New Debt Claim” link (200). During the reporting process, the creditor is given the option to upload documents such as invoices, receipts, or contracts in order to validate the accusation of debt, providing proof in the event that the debtor fails to remember or believe that monies are owed. These documents are saved to the secured server, which may also host the database (220) and website. In the event of significant growth of the network, additional servers (210) may be employed to manage the increased traffic.

After the debt has been reported (20) to the CCB, the report is then relayed to the accused debtor via email or conventional postal mail (30), informing him or her of the reported delinquent payment or non-payment, as well as the identity of the accusing small business. Once the debtor is informed of the outstanding balance or debt, a grace period of 30 days is issued, during which time the debtor may opt to resolve the debt by paying the creditor in full (50), dispute the debt accusations (40), or simply ignore or remain apathetic towards the accusation (60) for the duration of the 30 days. If the debt is not resolved within 30 days, the debtor's identification information is added (70) to the database (220) formally, such that it is available for other companies of the network to be informed of the individual's delinquency.

In the event that the accused individual admits to the debt and agrees to pay the outstanding balance to the creditor in full (50), the debtor will click on the provided direct link to the Consumer Credit Bureau's website (230), found in the notification email, which will provide instructions for contacting the creditor for repayment of the debt, confirmation of repayment, and the clearing of his or her name from the database (220). Given that the present invention is designed to help small businesses, only visitors representing a business may sign up (900) to create an account to attain access to the database (220). Businesses wishing to sign up (900) will have their credentials confirmed such that only reputable and established small businesses are provided access to the website. New accounts will be vetted by the webmaster or network administrator. This is to ensure that fraudulent claims are kept to a minimum, easing the stresses on the administrator of the network, who will oversee all submitted debts and attempt verification of the creditor's claims. Therefore, debtors accused of delinquent payments will not be required, and in fact are unable to create an account with the CCB to resolve or dispute their debts.

In the event that the accused individual elects to dispute the debt accusations (40) after being informed of the debt (30) via the CCB, the debtor will click on the provided direct link to the Consumer Credit Bureau's website, found in the notification email, which will provide instructions for how to begin the process of disputing a debt claim. Instructions will include a link to the network, which, upon clicking, will prompt the debtor to enter their name, address, and telephone number. The server (210) will then verify the name and number which will be cross-referenced against the database (220) entry. An automated phone call will be made giving the verified debtor an access code, providing the debtor access to his or her debt information, including the small business making the debt accusation, as well as the Debtor Resolution (1000) page. Temporary access will be granted for preferably 30 days, during which time the debtor is suggested to resolve the debt with the creditor prior to the debt going public to the network of companies on the website (230). After 30 days, the access code expires, and the debt is made public to the website (230) if left unresolved.

In the event that the disputed debt is found to be faulty or in error (90), the creditor will remove the temporary, grace-period entry (100) from the database (220), ensuring persons falsely accused are not formally added to the network for view by other member businesses of the network. A submitted debt can be found to be faulty (90) through documentation of proof of payment by the accused debtor, or other evidence. The resolution of the accusation for the debtor will also begin with the initial notification email; however, much of the discussion and resolution of the debt will be managed through the Debtor Resolution (1000) page.

The Debtor Resolution (1000) page of the secured, network based website (230) is configured to be contextually sensitive depending upon the user accessing the page. If the user is a verified small business, logged into the network, then the formal “View Resolution Page” (300) link will be accessible. However, if the visitor to the site is merely a debtor wishing to resolve a debt or check on a debt's status, he or she will only have access to the “Debtor Resolution” (1000) link, which directs the debtor to their private Debtor Resolution page. The primary difference is that, in the preferred embodiment of the present invention, the creditor's “View Resolution Page” (300) link provides access to all outstanding debts owed to that specific small business' account, including additional options specific to businesses, including the capacity to post new debt claims. However, the Debtor Resolution (1000) page will only display the specific debtor's debts, as well as contact information for the company or companies providing the accusation of debt(s).

In FIG. 2, the preferred embodiment of the website (230) representation of the present invention can be seen. This is the view that the creditor would see upon logging into the network. It highlights the “Post New Debt Claim” (200) link, which provides the creditor with the ability to report a debt (20) to the Customer Credit Bureau via the website (230) and create a new pending database (220) entry. The “Search” bar (400) is used by creditors to search the database for a specific individual. Searches may be performed at the will of the creditor, and searches may be made based on the debtor's address, name, telephone number, or email address. Upon running a search from the Search bar (400), a list of results will be loaded into a spreadsheet or grid (700) as seen in FIG. 2. The results will display all available information regarding the individual searched for, including the debtor's name, address, email address, telephone number, and current debt status (600). Additional information can be found by clicking on an individual name from the grid (800), which will load a page displaying the company or companies that the debtor owes monies to, plus additional information regarding debts in the resolution process, as well as the history of the individual's debt as logged by the network. The “Debtor Resolution” (1000) link will not be available to creditors, as the button or link will disappear upon logging in with the “Log In” (500) link as a registered user (a small business). This is because the creditor will resolve debts from the “View Debt Resolution Page” (300) link, providing more follow up options for the creditor than the debtor's version of the page.

In order for a debt claim to be reported (20) against a debtor, a specific process should be followed. First, a creditor must be registered as a user of the Consumer Credit Bureau; if not registered, the business must ‘sign-up’ (900) to use report against an individual. Second the user must ‘Log In’ (500) to the network. Third, the user clicks the “Post New Debt Claim” button (200), which opens a dialog window designed to gather information pertaining to the debtor and the debt being claimed. The accusing creditor or business must provide, at minimum, a first name, last name, and address in order to submit a report (20). This is to ensure that the accusation is directed at the correct individual, in the case of similar or like names. Next the accusing creditor will be asked to supply optional documentation to backup the claim, such as an invoice that isn't paid, or a contract. If the debt is called into dispute by the debtor, and the creditor cannot produce sufficient evidence to back up the debt claim, the debt and the debtor's information will automatically be removed by the site administrator. The creditor will have a later option to upload documents in the event of a disputed claim. Upon uploading the optional documents and submitting the report (20) to the Consumer Credit Bureau, an automated email (30) will be sent to the debtor if an email address was provided by the creditor during the report (20), or an automated phone call will be made to the individual instead, provided that a phone number was supplied to the Consumer Credit Bureau's website (230) by the creditor during the report (20). In the automated email (30) or phone call, the accused debtor will be informed that he or she has been reported to the Consumer Credit Bureau network website (230), and that he or she has a grace period of 30 days to resolve the debt, otherwise the reported debt accusation will become a formal entry into the database (220) of individuals with outstanding balances with one or more of the small businesses or crediting members. The email (30) or phone call will direct the accused debtor to the Consumer Credit Bureau website, where he or she may be granted access to the “Debtor Resolution” (1000) page of the site, wherein the debtor can view any supporting documents provided by the creditor (if available), as well as acquire contact information of the creditor to facilitate debt repayment. After the 30 days have passed, an automated email will be sent to the creditor, requesting a status update of the debt. The email will only provide two options to indicate the status of the debt: 1) “Debt is currently being resolved,” or 2) “No resolution has been made, post debt to database (220).” From within the “View Debt Resolution” (300) page, creditors will be able to relay additional details pertaining to the debt status (600), including if the debt has been partially paid, paid in full, currently in dispute, or currently being resolved. In the event that the debt is not resolved prior to the end of the 30-day grace period, the debt entry associated with the accused individual will be posted (70) to the relational database (220) for all other member businesses to view at their leisure or necessity. The debt may still be paid after the grace period, however the database entry will not be removed for a period of five years, regardless of if the debt is ever paid or not. However, the debt entry may be edited to indicate the debt has been “Paid,” and well as to list the date the debt was repaid.

A finalized relational database (220) debt value entry may be edited in three ways after it has been posted to the relational database (220). By one method, once payment is made, the creditor may remove the numerical value of debt from the individual's entry independently from intervention or assistance, after logging in (500) to the website (230) on his or her own, and clicking “Edit Database Entry”. Oftentimes, this will not be required, as each time the creditor logs onto the site, a temporary pop-up window will appear, requesting that the creditor update debtor information pertaining to individuals reported by the creditor. A list of all reported individuals and their debts will be provided in the pop-up, whereupon clicking on one of them will open the entry, displaying all available information pertaining to the indebted individual, and allow the entry to be edited. Another way in which a database (220) entry may be edited to update a debt report (20) is directly through the “Debtor Resolution Page” (300). From the Debtor Resolution Page (300), debtors can go to notify the network and accusing creditors that the debt has been ‘paid in full,’ ‘partially paid,’ ‘in resolution,’ or ‘unresolved.’ Once this is done, an email will be sent to the creditor, notifying them that the debtor has contacted the network, and is claiming that the debt has been paid. This automated email to the creditor will prompt the creditor to confirm the payment amount and to click a link to remove the debt owed directly. Finally, the third way debt values may be edited is via the systems administrator or webmaster of the secure website (230). In the event that a creditor fails to respond to a given debtors request to remove debt (having paid in full), the debtor may then mail or email supporting documentation, such as checks or credit card authorization of amount, to verify that the debt has been repaid. In this event, the system's administrator or webmaster will edit the entry for the debtor, given that the creditor who made the original accusation or report (20) is unreachable.

It should be understood that, in alternate embodiments of the present invention, it can be conceived that a direct avenue may be provided to connect creditor to debtor through the medium of the website. This could include, but is not limited to providing an instant messaging client or a comments dialog to establish communication between the two parties to facilitate debt resolution swiftly. This could be based within the website (230) framework, and hosted on the same secured server (210).

Additionally, in alternative embodiments of the present invention, it can be envisioned that debtors and creditors could employ internet-based video conferencing to expedite the debt verification process. The creditor would then be able to show, essentially in person, the individual's signature on a contract they failed to pay for, facilitating conversation between the two parties, and making it easier to resolve the debt. It can also be envisioned that, in an alternate embodiment of the present invention, a direct-pay client such as PayPal may be employed to become the primary medium of payment between the creditors and debtors. Payments could be made directly to creditors from within the website (230), once debtors are informed of their debt via the automated email (30). A link would then be provided in the email (30), providing the option for the debtor to pay the creditor directly via PayPal or a similar direct-pay service.

I claim:

1) A system for maintaining a history of credited transactions among creditors comprising:
a computer;
wherein said computer is connected to a network;
a relational database;
wherein said computer is hosting said relational database on said network;
wherein said relational database contains information pertaining to a set of individuals who maintain an outstanding balance greater than $150.00 with a creditor;
a server;
wherein said server hosts a website; and
wherein said website provides access to said relational database for creditors as subscribers.

2) The system of claim 1, wherein said subscribers report debts to said website.

3) The system of claim 1, wherein said subscribers have access to said information pertaining to the set of individuals who maintain an outstanding balance greater than $150.00 with the creditor.

4) The system of claim 1, wherein said subscribers are capable of editing information within said relational database concerning credits paid or owed to said subscribers.

5) The system of claim 1, wherein said subscribers may blacklist a customer upon reaching a certain debt limit.

6) A method for maintaining a history of debts individuals maintain with creditors comprising:
a computer hosting a secured website;
the computer providing access to the secured website to subscribers;
the computer maintaining a relational database containing information pertaining to debts remaining to be paid to creditor;
the computer creating an account for each subscriber;
the computer enabling subscribers to enter information pertaining to their customers' personal information into the relational database;
the computer enabling subscribers to enter information pertaining to their customers' debts into the relational database; and
the computer enabling subscribers to update the information pertaining debts due to the subscribers upon payment.
